(19) United States
(12) Patent Application Publication
(10) Pub. No.: US 2020/0290068 A1
(43) Pub. Date: Sep. 17, 2020

(54) NOZZLE CONSTRUCTION FOR THERMAL SPRAYING BY MEANS OF A SUSPENSION OR A PRECURSOR SOLUTION

(71) Applicant: FRAUNHOFER-GESELLSCHAFT ZUR FOERDERUNG DER ANGEWANDTEN FORSCHUNG E.V., Muenchen (DE)

(72) Inventors: Stefan LANGNER, Dresden (DE); Richard TRACHE, Dresden (DE); Filofteia-Laura TOMA, Dresden (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 16/473,011

(22) PCT Filed: Dec. 19, 2017
(86) PCT No.: PCT/EP2017/083546

§ 371 Date: Jun. 24, 2019

(30) Foreign Application Priority Data
Dec. 23, 2016 (DE) 10 2016 125 587.4

(51) Int. Cl. B05B 7/20; B05B 7/22; B05B 7/14

(52) U.S. Cl. CPC B05B 7/205; B05B 7/1486; B05B 7/226

(57) ABSTRACT

The invention relates to the nozzle construction for thermal spraying by means of a suspension, in which particles are contained, or a precursor solution, by means of which particles or precursor solution a layer is formed on a substrate, and which suspension or precursor solution is fed into a burner chamber or into a plasma torch, in which heating and acceleration of the particles is achieved, wherein a connection point for feeding the suspension or the precursor solution, a holder, and a nozzle insert are present. The nozzle insert has, with a tubular element arranged in the direction of the burner chamber or perpendicularly in HVOF flame or plasma torch and with an end face arranged opposite the burner chamber, a flange-shaped expanded section, which lies against a seat formed in the holder in the installed state. The contours of the flange-shaped expanded section and of the seat are complementary to each other such that the surfaces of the flange-shaped expanded section and of the seat are in direct contact with each other and an end stop and a seal are formed in this region.

The invention relates to a nozzle construction for thermal spraying using a suspension or a precursor solution. In this case, the suspension, which contains particles with which a layer can be formed on a substrate, is fed into a burner chamber or into the emerging flame/plasma jet. The suspension is formed with a liquid and particles. Particles that may be used are metallic and/or ceramic particles, the mean particle size d₅₀ of which may be in the nano/submicrometer range up to 5 μm. Rather than a suspension, a precursor solution can be injected.

In the burner chamber, the particles can be heated and accelerated with a gaseous or liquid fuel using the high velocity oxy-fuel (HVOF) process by oxidation of the fuel. The liquid with which the suspension has been formed is either evaporated, pyrolyzed or oxidized.

In the atmospheric plasma spraying (APS) process, the suspension is fed into the plasma torch. There, the suspension liquid is evaporated and the resultant particles are heated.

For feeding the suspension, use is made of nozzles, these causing problems in particular at small inside diameters of below 500 μm. Thus, it is not possible to achieve a suitable jet shape, in particular in the form of a full jet, of a suspension jet emerging from a nozzle opening, which can be sustained. As a result, separation of individual droplets and collapse of the jet can occur.

As a result of the manner of production of nozzle bores through which the suspension flows, angular deviations from the desired prescribed axial direction of the direction of jet motion arise. The axial direction in which the suspension jet emerges from the nozzle bore can also change gradually or constantly, such that a “dancing” jet passes into the burner chamber or into a plasma torch.

A reduction in the volume flow and/or an increase in the speed at which the suspension flows through the nozzle bore and emerges therefrom can also occur if, for example, contaminants have settled in the nozzle bore or a ridge has been formed there.

These drawbacks occur substantially for production reasons. Usually, the nozzle bores are produced by drilling during a machining process or by erosion. Here, erosion is preferred in particular for small inside diameters. In any case, however, it is not possible to maintain the desired and required dimensional accuracy of the inside diameter and the homogeneous cylinder shape. Particular problems arise here in the region of the inlet and outlet opening of nozzle bores. A ridge can form.

Particularly disadvantageous are the relatively high costs for manufacturing, which are required in the case of the usual and desired small inside diameters and a high aspect ratio (ratio of length to inside diameter).

Deposits within the nozzle bore can be removed only with a great deal of effort, if at all.

Errors in jet formation have a negative effect on the result of coatings produced by thermal spraying.

Therefore, it is an object of the invention to specify possible ways of feeding a suspension during thermal spraying, with which the quality can be improved and at the same time the costs lowered and the flexibility increased.

According to the invention, this object is achieved by a nozzle construction that has the features of claim 1. Advantageous configurations and developments of the invention can be realized with the features set out in the dependent claims.

The nozzle construction according to the invention for thermal spraying using a suspension that contains particles, or a precursor solution, with which a layer is formed on a substrate, and the suspension is fed into a burner chamber, into an HVOF flame or into a plasma torch in which the particles are heated and accelerated, is formed with a port for a feed for the suspension or the precursor solution, with a holder and with a nozzle insert. In the following text, the feed will be referred to throughout as suspension feed.

The nozzle insert has a tubular element arranged in the direction of the burner chamber or perpendicularly to the HVOF flame/plasma torch, and, on the end face arranged opposite the burner chamber, a flange-like widened portion, which, in the installed state, bears against a seat formed in the holder, and in this case

the contours of the flange-like widened portion and of the seat are formed in a complementary manner to one another such that the surfaces of the flange-like widened portion and of the seat are in direct contact with one another, such that, in this region, an end stop and a seal are formed.

As the precursor solution, it is possible to use for example inorganic salts or organometallic compounds dissolved in water or in organic solvents, for example ethanol, isopropanol or butanol.

In particular after the suspension feed, which may be a line or a hose, has been released from the port, the nozzle insert can be inserted into the holder through a corresponding opening and then the flange-like widened portion can be pushed up to the seat. After the suspension feed has been attached, the nozzle construction can be used as intended. It is obvious here that a nozzle insert can be replaced with a new or different nozzle insert. Replacement may be on account of wear or be carried out when the feed conditions of the suspension are intended to be changed. In this case, a new or different nozzle insert can have a changed inside diameter of the tubular element and/or a changed length of the tubular element.

The flange-like widened portion in this case has the same geometric design and dimensions at the nozzle inserts.

The tubular element and the flange-like widened portion should advantageously be two individual parts that are connected together in a force-fitting, form-fitting and/or materially bonded manner. The connection can in this have been produced for example by adhesive bonding, soldering, welding and/or a press fit.

Tubular element can be parts of a tubular semifinished product that have been cut to the desired length. Such semifinished products can be produced cost-effectively using production processes known per se.

The flange-like widened portion can advantageously be formed from or with a polymer and the tubular element from metal, preferably from passivated stainless steel. A flange-like widened portion can in this case be formed entirely from a polymer. However, it is also possible for only a coating formed with a polymer to be present in the region of the flange-like widened portion or for a composite material with a polymer to be used therefor. As a result of the properties of the polymer, the seal can be improved. Furthermore, the production of a nozzle insert formed in such a way as a metal-polymer composite can be achieved easily in that the flange-like widened portion can be molded easily onto a tubular element by plastics injection-molding.

Advantageously, there can be a conical region on the flange-like widened portion, said conical region preferably bearing against the seat of the holder in the installed state. A cylindrical region that is formed inside the holder and in the region of the seat can fulfill a guiding function for the nozzle insert when the dimensions and geometric design thereof have been matched to the external contour of the flange-like widened portion away from a conically formed region.

The tubular element should have a maximum inside diameter of 0.8 mm, preferably 0.25 mm.

It is also beneficial when the holder can be cooled; to this end, ducts, through which a (gaseous or liquid) fluid for cooling can flow, can be formed in the holder or between the holder and nozzle insert.

Between the inner wall of the holder and the outer wall of the tubular element there may be a radially encircling gap, with which a thermal insulation effect can be achieved. In this region, there may be an annular element, in which a bore is formed, through which the tubular element can be guided. In this case, the inside diameter of this bore should be matched to the outside diameter of the tubular element, such that the annular element can fulfill the function of guiding and radial fixing for the tubular element. The annular element should to this end consist of a material with poor thermal conductivity.

With the invention, unit prices of less than €1 can be achieved for the nozzle inserts. It is quick and easy to substitute them for a different or worn nozzle insert. In particular the tubular elements can be made available with high and constant dimensional accuracy, such that a respectively desired geometric design and dimensioning can be maintained.

As a result, a very readily reproducible and reliable feed of a suspension into the process of thermal spraying can be achieved. Merely by designing holders in a corresponding manner, nozzle inserts can be used on burners (spray guns) from different manufacturers and for thermal spraying processes that can be carried out in different ways.

Through a suitable choice of a nozzle insert, this relating in particular to the inside diameter of the tubular element and the length thereof, different feed conditions into the thermal spraying process can be taken into consideration as required.

It is also possible to integrate the feed of a gas for atomizing the suspension. As a result, after passing out of the tubular element in the form of very small droplets (spray form), the suspension can be heated and in the process the liquid evaporated or oxidized and the particles heated and then accelerated in the direction of the substrate surface to be coated.

In the following text, the invention will be explained in more detail by way of an example.

In the drawing:

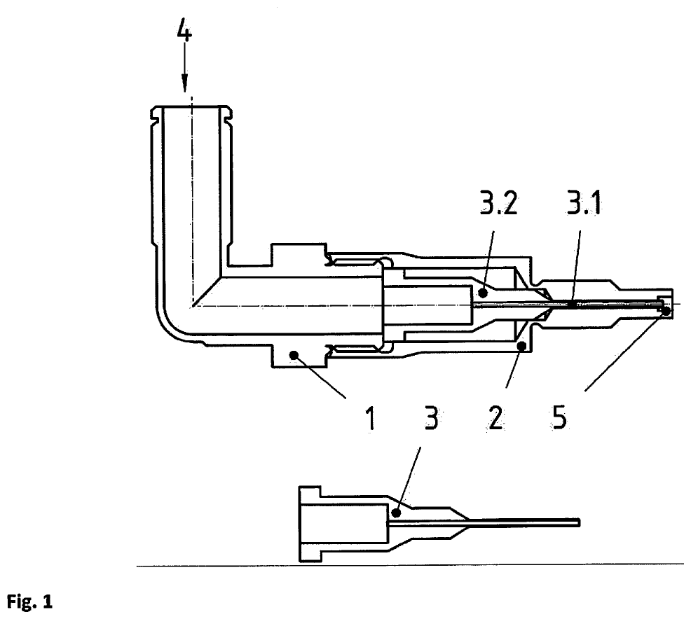

FIG. 1 shows a cross-sectional illustration through an example of a nozzle construction according to the invention.

In this case, a suspension feed 4, of which only a small part is indicated in FIG. 1, is fastened to a port 1. The port 1 can be a conventional connection with a union nut. The port 1 is present on a holder 2 that is hollow on the inside.

Following the separation of the connection between the port 1 and suspension feed 4, a nozzle insert 3 can be introduced from the side of the holder 2 that is open in the region of the port 1 and be introduced as far as a seat that is formed inside the holder 2.

The nozzle insert 3 is formed with a tubular element 3.1, on which a flange-like widened portion 3.2 is formed on the end face directed in the direction of the holder interior. The end face, directed in the direction of the outlet opening, of the flange-like widened portion 3.2 is formed in a conical manner. The seat in the holder 2 has a region formed in a conical manner in a correspondingly complementary fashion. At least there, the surfaces of the seat and of the flange-like widened portion bear directly against one another extensively. A region adjoining the latter in the direction of the port 1 can be formed as a hollow cylinder in the holder 2 and as an outer lateral surface of a cylinder at the flange-like widened portion 3.2 of the nozzle insert 3, and form a corresponding longitudinal guide for the nozzle insert 3 in the holder 2.

The tubular element 3.1 has in this example a length of 9 mm, an inside diameter of 0.25 mm and an outside diameter of 0.52 mm. It was obtained by a method of cutting to the desired length from a tubular semifinished product made of stainless steel.

At one of its end faces, the flange-like widened portion 3.2 was formed in a manner known per se by means of plastics injection-molding and in the process connected to the tubular element 3.1 there at least in a force-fitting and/or materially bonded manner. The flange-like widened portion 3.2 can be formed with virtually any desired polymer that is able to be processed by plastics injection-molding.

In the example shown in FIG. 1, an additional internally hollow sheathing 5, through which the tubular element 3.1 in the direction of a burner chamber (not illustrated) or in the direction of a substrate to be coated by means of thermal spraying, is present on the end face of the holder 2. The sheathing 5 can be a constituent part of the holder 2 or be fastened as a separate element to the holder 2, for example by means of a screw connection. The sheathing 5 can in particular fulfill a protective function for the tubular element 3.1.

1. A nozzle construction for thermal spraying using a suspension that contains particles or a precursor solution, with which a layer is formed on a substrate, and that is fed into a burner chamber or into a plasma torch in which the particles are heated and accelerated, wherein the nozzle construction is formed with a port (1) for a feed (4) for the suspension or the precursor solution, with a holder (2) and with a nozzle insert (3), and
the nozzle insert (3) has a tubular element (3.1) arranged in the direction of the burner chamber or perpendicularly in an HVOF flame or plasma torch, and, on the end face arranged opposite the burner chamber, a flange-like widened portion (3.2), which, in the installed state, bears against a seat formed in the holder (2), and in this case
the contours of the flange-like widened portion (3.2) and of the seat are formed in a complementary manner to one another such that the surfaces of the flange-like widened portion (3.2) and of the seat are in direct contact with one another, such that, in this region, an end stop and a seal are formed.

2. The nozzle construction as claimed in claim 1, characterized in that the flange-like widened portion (3.2) is formed from or with a polymer and the tubular element (3.1) from metal, preferably from passivated corrosion-resistant stainless steel.

3. The nozzle construction as claimed in claim 1, characterized in that the tubular element (3.1) and the flange-like widened portion (3.2) are connected together in a form-fitting, force-fitting and/or materially bonded manner.

4. The nozzle construction as claimed in claim 1, characterized in that there is a conical region on the flange-like widened portion (3.2).

5. The nozzle construction as claimed in claim 1, characterized in that the nozzle insert (3) is fastened interchangeably in the holder (2).

6. The nozzle construction as claimed in claim 1, characterized in that nozzle inserts (3) that have tubular elements (3.1) of different lengths and/or have different inside diameters are able to be fastened in the holder (2).

7. The nozzle construction as claimed in claim 1, characterized in that the tubular element (3.1) has a maximum inside diameter of 0.8 mm, preferably 0.25 mm.

8. The nozzle construction as claimed in claim 1, characterized in that the holder (2) is coolable.
